(19) United States
(12) Patent Application Publication
(10) Pub. No.: US 2002/0050297 A1
(43) Pub. Date: May 2, 2002

(54) Back wash valve

(75) Inventor: Bryson Richard Timney, Whangaparaoa (NZ)

Correspondence Address: YOUNG & THOMPSON, 745 SOUTH 23RD STREET 2ND FLOOR, ARLINGTON, VA, 22202

(73) Assignee: TRANS-TASMAN RESOURCES LIMITED

(21) Appl. No.: 09/984,730

(22) Filed: Oct. 31, 2001

(30) Foreign Application Priority Data
Oct. 31, 2000 (NZ) NZ 507, 919

(51) Int. Cl. F16K 11/04

(52) U.S. Cl. 137/625.5

(57) ABSTRACT

A valve, for diverting a flow of water to be passed in one direction or the reverse through a water rejuvenation bed (such as a filter for trapping detritus or organisms, or an ion exchange bed) comprises a ported tubular body within which a free spool carrying a plurality of partitioning seals may slide between a first position and a second position by hydraulic pressure applied to the seal at one end or the other of the spool. The hydraulic pressure from a pilot line, is applied momentarily through a solenoid valve actuator sealed over at each end of the tubular body in a “push-push” symmetrical configuration and driven by a controller according to a timer; optionally also supplied with bed performance signals (such as trans-filter pressure). The solenoids themselves require little driving power and the valve is simple in construction.

### FIELD

This invention relates to valves for controlling the flow of fluids; more particularly to valves for controlling the flow of liquids undergoing passage through a filter or the like, and to valve actuating means therefor.

### BACKGROUND

A number of water flow control requirements involve the passage of water through a water processing unit such as (a) a filter, for particulate solids (in swimming pools, for the production of potable water, or for the rejuvenation of waste water such as sewage or industrial waste liquids, or (b) an ion-exchange bed such as for modifying the hardness of water. These water processing units may require periodic back flushing, such as for washing detritus from a filter into a waste container, or for washing brine through an ion-exchange bed so that the collected ions are replaced with sodium ions. Here, the back washing action is intended, from time to time, to reverse the direction of flow through the filter and carry the solids away from the filter to a dedicated storage tank.

Surprisingly there are few products of the control valve type available for the automatic control of water undergoing rejuvenation and particularly filtration. This water tends to flow about the water processing unit in relatively large volumes but at relatively low pressures. The inventor recognised that a particular problem to be solved could be stated as “to provide a valve and actuator for the directional control of water during a water processing (such as a filtration) process”. It would be useful if the actuator was a low power, mechanically simple, and relatively passive device having five ports (analogous to a DPDT electric switch) in order to minimise the overall cost and complexity of a waste water facility. Prior-art solutions (such as Canadian patent 2,263,844) to valve design involving motor-driven valve movement including elaborate mechanisms often with limit switches, motor speed reduction drives, and reversible motors. Some designs including internal spools and multi-port valves are known. Kyowa Sangyo KK (pub. no JP56147977) teaches, for a swimming pool filter, a four-port valve having a cylindrical body and an internal spool. Again it is driven by a geared motor with brake, speed reducer, limit switches and the like. Designs of this type raise the price of a water-handling installation particularly because of the complexity of the actuator section of the back washing valve.

### OBJECT

It is an object of this invention to provide an improved control valve particularly but not solely for use in intermittent back-washing of a water filter, or at least to provide the public with a useful choice.

### STATEMENT OF INVENTION

In a first broad aspect this invention provides a control valve of the type wherein an initial directed change in fluid flow is subsequently amplified in order to change the state of a valve and thereby divert a mass flow of fluid to and from from a first direction and a second direction.

Preferably the initial directed change results from an injection of an external source of energy, and a preferred external source of energy comprises an electric current capable of changing the state of an electromagnetically driven valve, capable in turn of admitting a pilot fluid under pressure into a space where it may push against a face of a piston forming part of a valve spool.

Preferably the change of state of the pressure-driven valve is capable of permitting a flow of fluid to enter a cylinder and to apply a force to a control surface of a piston, having attached thereto a spool as herein defined, the piston and spool being capable of sliding in an axial direction within a cylinder so that on the application of pressure the piston is caused to move between a first state and a second state.

Preferably the piston is caused to move between a first state and a second state by application of a pressure at either a first control surface or a second control surface.

Optionally the piston is caused to return to a first state from a second state by a restoring force imposed by a biasing means.

Preferably the control valve is of the three-port type wherein an inlet port may be connected to either one of two alternative outlet ports depending on whether the piston is presently in a first state or a second state.

More preferably the control valve is of the five-port type wherein each of two inlet ports may be connected to a corresponding either one of two alternative outlet ports depending on whether the piston is presently in a first state or a second state.

In a second broad aspect the invention provides a back wash valve for changing the route of flow of a liquid, wherein the valve includes an elongated body having a valve spool bore, having at least one open end capable of sealably receiving at least a first actuator, and having at least one inlet port, capable of accepting a conduit carrying the liquid, and more than one outlet port each capable of accepting a conduit, along the sides of the body, a free elongated valve spool held slidably within the tubular body; the spool having a shaft fixedly supporting a plurality of annular sealing structures each capable of making a seal against the valve spool bore of the body, the spool including an annular sealing structure at each end of the shaft, the spool being capable of being moved in an axial direction between a first working position (in order to sealably limit a flow of liquid within the tubular body of the valve to passage between a first set of predetermined ports), and a second working position (in order to sealably limit a flow of liquid within the tubular body of the valve to passage between a second set of predetermined ports), the first actuator being sealed against an end of the tubular body of the valve thereby forming a closed space with the adjacent annular sealing structure at an adjacent end of the spool, the first actuator, when in an activated state, being capable of admitting a pilot fluid under a pressure into the closed space, and when in a non-activated state being capable of permitting the fluid to leave the closed space so that in use the admitted fluid is capable of pressing against an end of the spool and hence causing the spool to move from the first position to the second position.

Preferably a second actuator is sealably attached to the remaining open end of the body of the valve, thereby, on activation, of restoring the position of the spool within the body of the valve from the second position to the first position.

Preferably at least one actuator is activated by the passage of an electric current through a winding of a solenoid comprising a part of the actuator, so that movement of an armature of the solenoid controls admission of the pilot fluid into the closed space.

Optionally at least one actuator is activated by pneumatic means capable of causing a change of state of a pilot valve so as to allow admission of the pilot fluid into the closed space.

In a related aspect the invention provides a back wash valve as previously described in this section for causing a reversal of a usual direction of flow through a liquid processing unit such as a filter or an ion exchange resin, wherein a first port is provided for connection to a first side of the liquid processing unit, a second port is provided for connection to a second side of the liquid processing unit, a third port is provided for accepting a flow of liquid from a source, a fourth port is provided for carrying away a flow of processed liquid to a destination, and a fifth port is provided for carrying away an occasional flow of rejected material to a dump, so that in use when the spool of the valve is in the first position the liquid from the source passes through the liquid processing unit in a forwards direction and to the destination, while when the spool of the valve is in the second position the liquid from the source passes through the liquid processing unit in a backwards direction and to the dump.

Preferably the valve is provided with a control device capable of causing activation of the at least one actuator in a controlled sequence based on elapsed time.

Optionally the valve is provided with a control device capable of also causing activation of the at least one actuator in response to detection of a signal indicating that the liquid processing unit has reached a state requiring a back washing procedure.

Preferably the signal indicating that the liquid processing unit has reached a state requiring a back washing procedure comprises a differential pressure across a filter bed.

Alternatively the signal comprises a downstream conductivity measurement for the case of an ionisation bed.

Alternatively the signal comprises a downstream sodium ion concentration measurement for the case of an ionisation bed.

### PREFERRED EMBODIMENT

The description of the invention to be provided herein is given purely by way of example and is not to be taken in any way as limiting the scope or extent of the invention.

### DRAWINGS

FIG. 1: is a diagram showing an example interconnection of pipes, a back washing valve, a pilot line, and a controller according to the invention.

FIG. 2: shows the same example with the back washing valve in a second state, for a second flow pattern. The controller is connected to a pressure transducer.

FIG. 3: shows an assembled electromagnetic actuator for the valve of FIGS. 1 or 2.

FIG. 4: shows a disassembled electromagnetic actuator as in FIG. 3.

FIG. 5: shows the spool and tubular body, with ports, of the back wash valve.

FIG. 6: shows an assembled back wash valve including saddles over the tubular body.

FIG. 7: shows a version wherein the actuator valves reside in the controller itself.

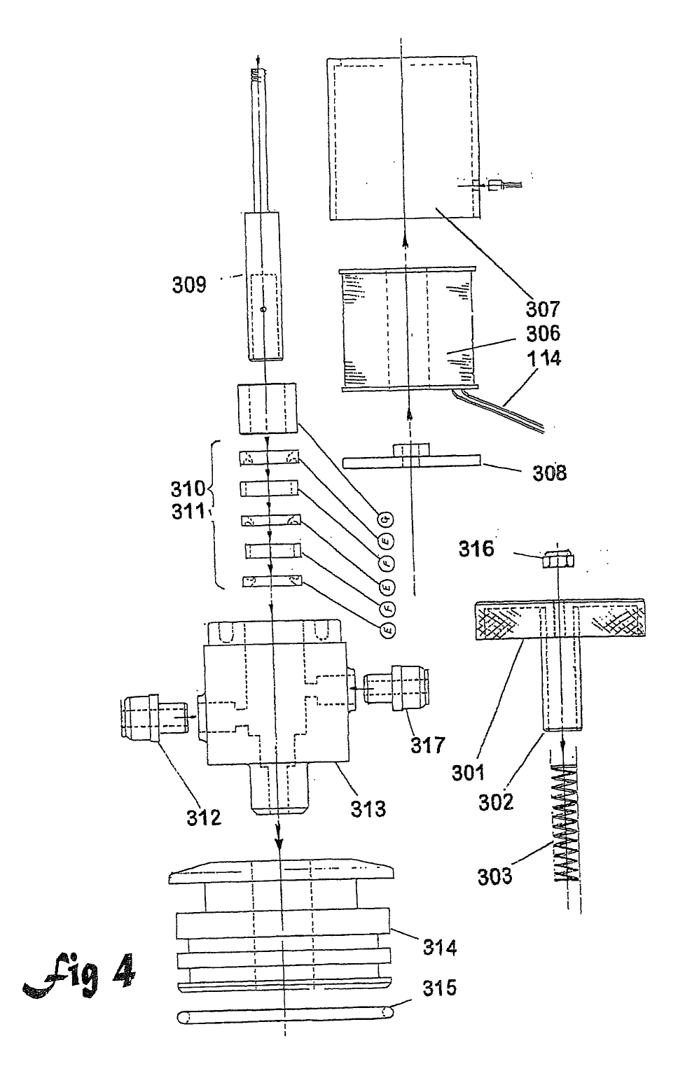

The term “actuator” is used in this text to refer in particular to the discrete solenoid-operated valve as shown particularly in FIGS. 3 and 4, although more precisely the term should also include the driven disk-shaped seal at either end of the spool within the sealed space, because that seal serves as a piston surface to be pushed by an admitted fluid under pressure.

### EXAMPLE 1

This invention relates to a type of self-cleaning multi-port valve developed for applications in handling of low-pressure water in reasonably high volumes as it is passed through a water enhancement unit (filter bed or ion exchange unit, for example),. The valve is known as a “back-washing valve” because a principal application of the valve is in managing a filter, by reversing the direction of flow from time to time for a brief period in order to flush collected material from the filter backwards and into a waste pipe.

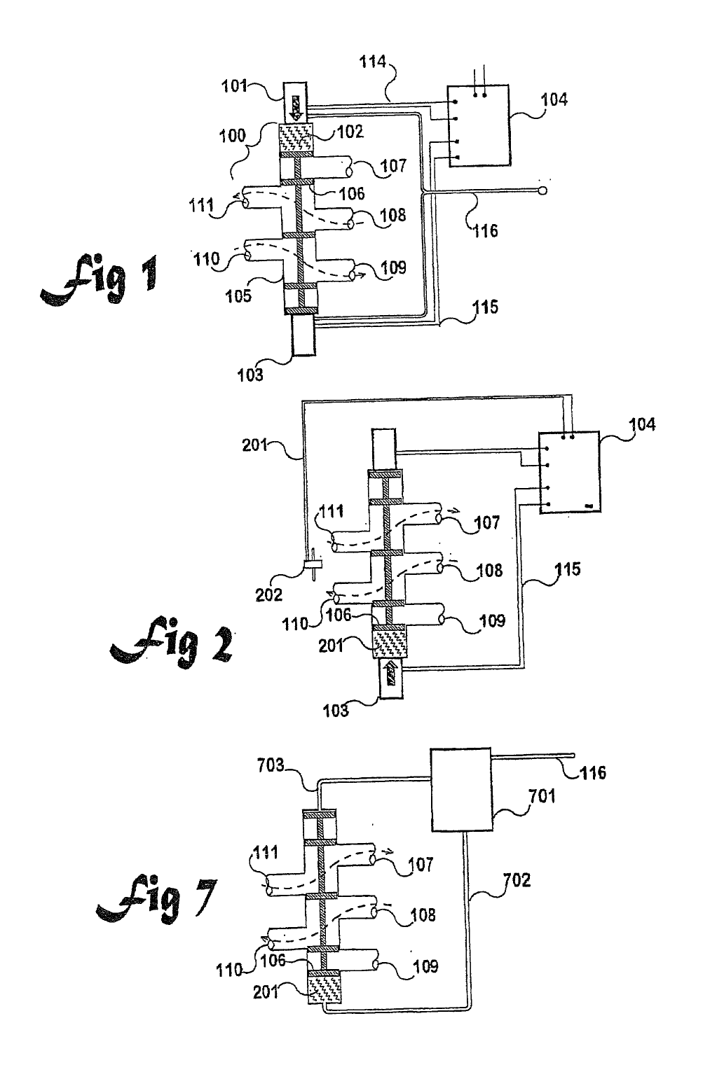

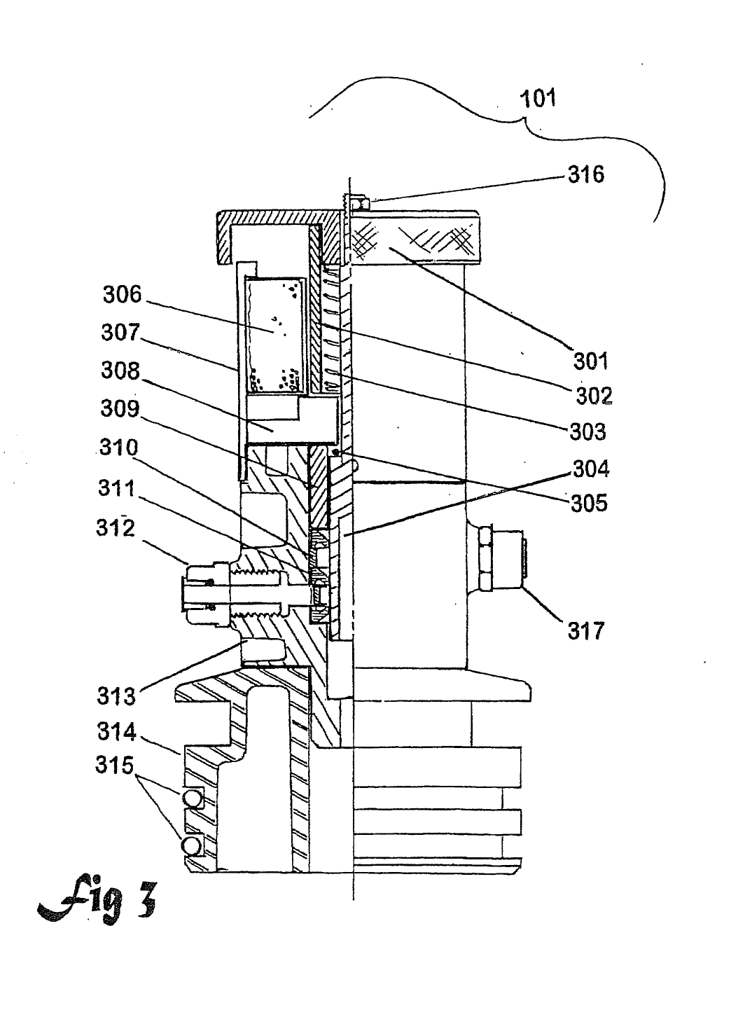

FIGS. 1 and 2 show an overall diagram of a system wherein a five-port example valve according to the invention is shown in a first state in FIG. 1, and a second state in FIG. 2. To identify the parts in detail, 101 and 103 are actuators; one being sealed onto each end of a cylindrical valve assembly 100 having a number of ports cut into a cylindrical body 105. In this case there are five ports: 107 (connected to waste and used only occasionally), 108 (input from supply pump), 109 (filtered output), 110 (flush/wash flow to filter, otherwise return from filter) and 111 (normal flow to filter, otherwise carries waste from filter). The dashed lines indicate the usual direction of flow in each state. Flow is determined by the position of an internal spool or valve assembly 106 which comprises a substantially rigid stem and a plurality of disc-shaped partitioning seals each of which is capable of forming an annular seal within the cylinder 105. The spool 106 is capable of axial movement within the cylinder 105 between a first position (as in FIG. 1) and a second position (as in FIG. 2). When, as in FIG. 1, the actuator 101 is energised so as to push the spool 106, fluid is admitted under pressure from a pilot supply into a space 102 defined by a sealed (314-315) base of the actuator against the tube 105, so forcing the spool to move. At the same time, previously used pilot fluid which may have been present in the opposite space 201 is permitted to escape. The resulting flow of two streams of fluid through this back wash valve is as shown by the dashed lines. Conversely, as in FIG. 2, if the actuator 103 is instead energised, pilot fluid is admitted under pressure into a space 201 so restoring the spool to the original position. At the same time, pilot fluid which may have been present in the opposite space 102 is permitted to escape. Hence a current of waste water may be passed through a filter (placed between ports 110 and 111) and from time to time accumulated detritus can be back-washed or flushed out through a waste outlet (107) kept separate from the main outlet (109) from the assembly.

It will be realised by one skilled in the art that a five-port back wash valve is not the only version of valve compatible with the objectives of this invention. For example, two three-port valves are almost equivalent, and an installation may be scaled up by using more than five ports.

This type of actuator is distinguished from the prior art by making use of flowing pilot fluid (typically a line 116 of mains water supplied at a moderate pressure) to cause the internal spool to change position. In the preferred version, the pilot fluid is controlled by a relatively small and low-power solenoid valve. Usually, the expelled pilot fluid is simply wasted. The amount used per cycle is small (about 100 -250 ml).

A controller 104 is provided to initiate a change in state from time to time. One mode of operation is to send a (for example) 15 second burst of electric current through wires 115 to actuator 103 every two to 24 hours, and follow that by a 15 second burst to actuator 101 through wires 114 in about two minutes time. This results in a periodic two-minutes back wash process. Other timings may be deemed more appropriate. Instead, a pressure sensor such as differential transducer 202 may be connected through wires 201 to the controller in order to sense the cross-filter pressure differential and cause a washing sequence to commence whenever the pressure rises above a preset amount indicating that the filter is becoming occluded. A preferred mode of operation is to rely on a time-base by default but allow either a pressure signal (from line 201) or a manual over-ride to set off a back wash sequence. A circuit for the controller 104 is not provided here; suitable circuits are well known in the art of process controllers. They may be based on mechanical timers, electronic timers, or microprocessors). The controller may be powered from a mains utility supply or, given the low power consumption, from a renewable source of electricity such as solar power.

For an ion exchange water purifier, downstream water conductivity (or sodium ion concentration) may be sensed in order to initiate a back-washing procedure. Also, it is usual to back-wash the resin with a salt solution such as brine, arriving through an extra inlet port (not shown in this example).

Typical water flow through the back wash valve assembly of the size to be described below is up to 400 liters per minute, at a pressure of typically 2 to 5 bar. Yet the actuator may be driven with just 12 volts, 4 amperes DC for 15 seconds in order to steer the main water flow in an opposite direction. It can be seen that the activating power involved is relatively small as compared to the power associated with the usual circulating volumes, and so the control system can be of low cost, low voltage, and can be safe as well as simple.

### ELECTRIC ACTUATOR EXAMPLE

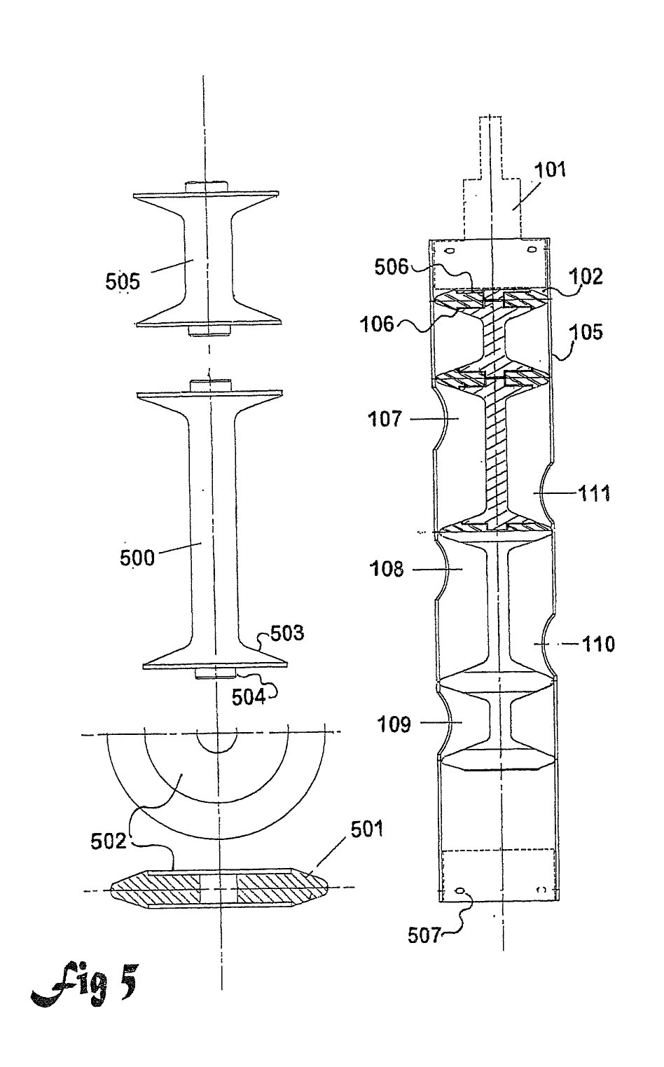

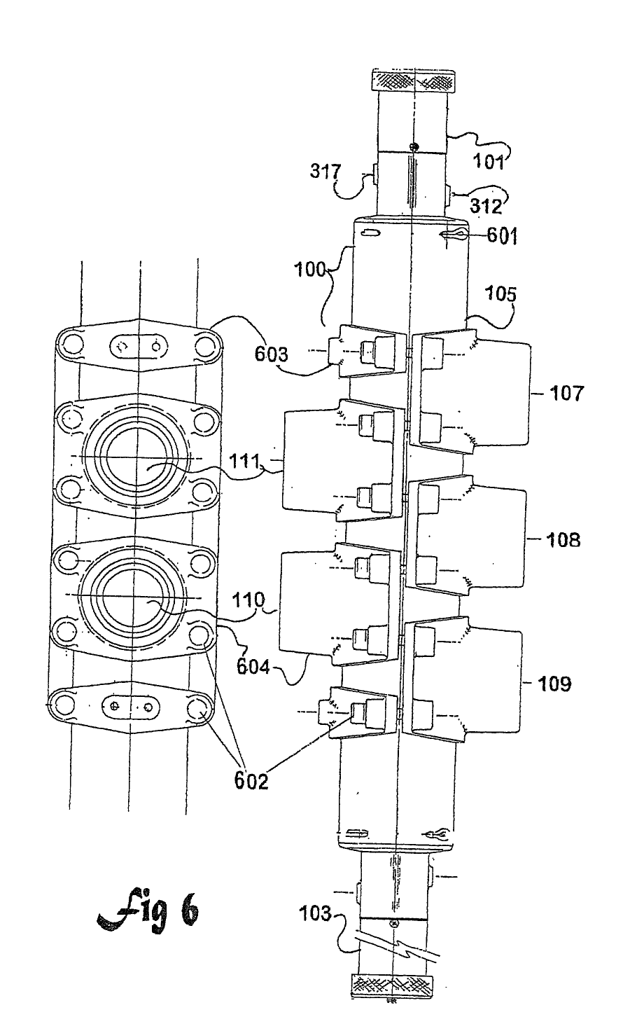

FIG. 3 shows details (half-section and half-exterior view) of an electrically driven (solenoid) actuator according to the invention, which may be actuator 101 from example 1. FIG. 4 shows the components in an exploded view. Components for sealing the actuator to the backflow valve (the “ram end seal”) include the plastic header 314 with several sealing rings 315, in the form of a plug that can be pushed into the end of the tube 105 and held in place by cotter pins 601 (see FIG. 6) passing obliquely through the deepest recess and through obliquely drilled holes such as 507 (FIG. 5). (Other forms of seal may be made, as known to one versed in the art). This sealing process results in the body of the valve acquiring a closed space sealed at one end by a moveable piston, being part of the spool (such as 506). (It may be proper to include this piston wihtin the term “actuator”). The manifold 313 is preferably glued into the header 314. 306 is a winding for generating a magnetic field which is completed through a magnetically permeable (here, corrosion-protected iron) circuit comprised of a movable cap 301, the casing of the winding 307, an inner cylinder 302 and a retainer/bulkhead 308. If no current flows in the winding 306 the cap is biased so as to be pushed upwards (outwards) by the internal compression spring 302 and the valve formed by the internal sealed piston 309 allows any pilot fluid in the space 102 (FIG. 1) to flow out through the connector 317. Current in the winding 306 provides a magnetic force tending to cause the cap (armature) to be pulled downwards, so moving the internal sealed piston downwards (inwards) and allowing a pilot fluid under pressure to be admitted from connector 312 axially downward into the space 102 (FIG. 1). This pressure acting on the piston of surface area about 28.2 cm² (in this Example) is persuasive. The pilot fluid under pressure is sealed from the interior of the solenoid by seals 310-311, a set of “O” rings and shaped supports about the piston 309; these seals being commercially available components.

### REMOTE ACTUATOR EXAMPLE

FIG. 7 illustrates a version in which the valve portion of the actuators previously described are situated remote from the back wash valve; preferably within the controller. A pilot fluid (preferably water) is fed into the controller at 116. Pipes 702 and 703 carry, from time to time, control fluid under pressure into either of sealed spaces 102 and 201 respectively and cause the end of the spool to be forced away (here it is spool end 106 being displaced by fluid in space 201). The fluid in the non-pressurised space is forced back to the controller and to a sink by movement of the spool 106.

### SPOOL AND MANIFOLD

The preferred five-way back wash valve itself (without the ram actuators 101, 103) is shown in detail in scale drawing FIG. 5. The internal diameter of the 1.5 mm thick stainless steel tube 105 is 60 mm; the length is 375 mm. Each port (such as 107) has a diameter of 33 mm. The spool 106 comprises a set of disk-shaped seals each 60 mm in diameter, assembled together with interconnecting shaft members at spacings such that the desired switching action of the valve is obtained—as indicated in relation to the sites of the ports 107, 108, 109, 110, and 111, and the spool positions shown in FIGS. 1 and 2. In either position the distant end of the spool is driven up against the base of the more distant actuator by pilot fluid pressure (admitted by activation of the nearer actuator) acting on the closer spool end. The seal material is preferably the plastics material known as “Desmopan 786”—a type of urethane. Each shaft member 500 of the spool is made with a flare 503 at each end; the final diameter of each flare being the same as the recess 502 provided in each face of each seal. (Short shaft members 505 are used at each end). A central spigot 504 passes into the central aperture of each seal, and each end of the assembly is terminated by a simple disk with a spigot as shown in section at 506. The entire assembly may be glued together or more preferably held in close apposition by means of a central transfixing bolt (not shown).

In order to couple the relatively light stainless steel tube to water carrying pipes or the like, we prefer to use saddles as shown in FIG. 6 each provided with effective sealing means (such as “O″ rings”) located within the arcuate, semicircular internal surface to be brought against the tube 105 of the valve, and on the exterior face with elongated pipe-accepting sockets compatible with fixing practices for the type of plumbing in use (be it plastic, copper, steel, or glass). The saddles are clamped in place around the tube 105 of the back wash valve and in line with corresponding apertures (eg 111). Saddle 603 is a typical valve-mounting saddle (top view at left, side view at right). Saddle 604 is a typical pipe-coupling saddle (top view at left, side view at right) and it will be noted that these straddle the pipe of the back flow valve 105 in a staggered way and are brought together with (preferably) cap screws fastened into threaded holes about saddle-to-pipe seals. FIG. 6 (right-hand side) may be regarded as a practical view of the diagrammatic valve of FIG. 1. Saddles provide for functional, effective pipe connections without reliance on welding, gluing, casting, or other means of making “T” connections to the back wash valve. A closed saddle my be provided as part of a kit.

### VARIATIONS

As previously mentioned, three or any other numbers of ports may be provided in a valve having similar actuating means.

If pilot fluid at only a low pressure is available a “fatter” valve than the 60 mm ID tube described may be used, giving a greater piston surface area for the pilot fluid to work against in order to reliably cause movement of the possibly stiff spool along the body of the back wash valve. Other sizes of valve can of course be constructed according to the principles of the invention as stated herein.

Materials other than those described may be used; for example a plastics tube may replace the stainless steel tube described, and rubber or polytetraflourethane or some other suitable plastics material may replace the polyurethane seals used in the spool. Indeed, a thick-walled tube, perhaps cast or otherwise shaped from a solid mass may avoid the use of the saddles described herein.

The symmetrical, push-push opposed configuration as shown in FIGS. 1 and 2 may be replaced in a version having an actuator at only one end and a resilient return means (such as a spring) contained within a sealed cavity at the other end of the valve to bias the spool 106 to return from a second state (as in FIG. 2) to a first state (as in FIG. 1) soon after power is removed from the only actuator.

A more powerful solenoid actuator may be employed to push the spool directly.

A bistable actuator may be constructed by means of two separate windings, either of which may be driven separately so as to cause either a push or a pull to be applied to the core. Or, a permanently magnetised armature may be used with a single, bidirectionally energisable winding.

As previously mentioned the electrically driven actuators described herein may be replaced by, for example, pneumatic or hydraulic actuators; that is, actuators in which a control signal is embodied in a pressure change within a fluid carried through a pipe from a remote valve to an actuating piston. This is useful in corrosive or in inflammable environments, because no electric solenoid valves are placed at the back washing valve. Potential spark hazards are absent.

### COMMERCIAL BENEFITS or ADVANTAGES

1. This valve is a simply maintained back wash valve for use in low pressure applications, including waste water treatment, swimming pool, and spa pool installations. Its use in a water line causes only a small pressure drop.

2. The valve is economical to make and to use.

3. The valve requires only a small amount of external energy to cause a change in state.

4. The small actuating force is compatible with solar-cell and battery technology and so can be used in waste water or potable water processing installations far from utility supplies of electricity. It is also safe for swimming-pool applications.

5. The seals of the internal spool wipe the interior of the valve, so keeping the interior clean.

6. Together with the controller, the back wash valve provides a complete solution for water rejuvenation involving periodic reversal of flow through a water processing bed such as a filter.

7. Existence of this invention makes water conservation more feasible such as in relation to water purification, to handling domestic or farm effluent, and to swimming facilities.

Finally, it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

1. A back wash valve for controlling the route of flow of a liquid, characterised in that the valve includes an elongated body having a valve spool bore, the body having at least one open end capable of sealably receiving a base of a first actuator, and having more than two ports along the length of the body, each port being capable of accepting a conduit carrying the liquid; the valve also including a free elongated valve spool held slidably within the tubular body so that the spool may move between a first working position and a second working position in order to control the route of flow of the liquid; the spool having a shaft fixedly supporting a plurality of sealing structures each capable of making a circumferential slidable seal against the valve spool bore of the body, including a like sealing structure at each end of the shaft, wherein the or each actuator comprises a mechanism capable of admitting a pilot fluid under a pressure into the closed space when in an activated state, so that the pressure against the sealing structure at the adjacent end of the shaft is capable of pushing the spool from the first position to the second position.

2. A back wash valve as claimed in claim 1, characterised in that a second actuator is sealably attached to the remaining open end of the body of the valve, thereby, on activation, of returning the spool within the body of the valve from the second position to the first position.

3. A back wash valve as claimed in claim 1, characterised in that a biasing force is applied to the spool by means of a resilient body capable of returning the spool within the body of the valve from the second position to the first position.

4. A back wash valve as claimed in claim 1 or in claim 2, characterised in that an actuator is activated by the passage of a remotely produced electric current through a winding of a solenoid-operated valve included within the actuator, so that a resulting change of position of the valve allows entry of the pilot fluid into the closed space.

5. A back wash valve as claimed in claim 1 or in claim 2, characterised in that at least one actuator is activated by fluid control means capable of causing a change of state of a pilot valve so as to allow admission of the pilot fluid into the closed space.

6. A back wash valve as claimed in claim 1 or in claim 2, characterised in that at least one actuator comprises an elongated conduit , sealed at one end to an end of the elongated body of the back wash valve so creating the closed space, and connected at the other end to a controllable valve capable of admitting the pilot fluid from time to time into the conduit and so into the closed space

7. A back wash valve as claimed in claim 2, for causing a reversal of a usual direction of flow through a liquid processing unit (such as a filter or an ion exchange resin), characterised in that a first port is provided for connection to a first side of the liquid processing unit, a second port is provided for connection to a second side of the liquid processing unit, a third port is provided for accepting a flow of liquid from a source, a fourth port is provided for carrying away a flow of processed liquid to a destination, and a fifth port is provided for carrying away an occasional flow of rejected material to a dump, so that in use when the spool of the valve is in the first position the liquid from the source passes through the liquid processing unit in a forwards direction and to the destination, while when the spool of the valve is in the second position the liquid from the source passes through the liquid processing unit in a backwards direction and to the dump.

8. A back wash valve as claimed in claim 5, further characterised in that the valve is provided with a control device capable of causing activation of the at least one actuator in a controlled sequence based on elapsed time.

9. A back wash valve as claimed in claim 6, further characterised in that the valve is provided with a control device capable of also causing activation of the at least one actuator in response to detection of a signal indicating that the liquid processing unit has reached a state requiring a back washing procedure.

10. A back wash valve as claimed in claim 7, further characterised in that the signal indicating that the liquid processing unit has reached a state requiring a back washing procedure comprises a differential pressure across a filter bed.
